(19) United States
(12) Patent Application Publication
(10) Pub. No.: US 2025/0268147 A1
(43) Pub. Date: Aug. 28, 2025

(54) P4215US00

(71) Applicant: Husqvarna AB, Huskvarna (SE)

(72) Inventors: Jens STARKE, Herbrechtingen (DE); Sven BÜLLESBACH, Kötz (DE); Armin HEINRICH, Lauingen (DE)

(21) Appl. No.: 19/059,958

(22) Filed: Feb. 21, 2025

(30) Foreign Application Priority Data
Feb. 26, 2024 (EP) 24159603.0

(51) Int. Cl. A01G 3/02

(52) U.S. Cl. CPC A01G 3/02

(57) ABSTRACT

A cutting tool comprises a first handle, a second handle, a first cutting part comprising a first cutting blade and a first fastening section extending away from the first cutting blade, a second cutting part comprising a second cutting blade and a second fastening section extending away from the second cutting blade, and a biasing means configured to pre-tension the first cutting blade and the second cutting blade away from each other. The first cutting part and the second cutting part are pivotably coupled to each other at a pivot point. The first fastening section is inserted into the first handle, and the second fastening section is inserted into the second handle. The first handle is fixedly coupled with the first fastening section by the biasing means, and the second handle is fixedly coupled with the second fastening section by the biasing means.

### CROSS-REFERENCE TO RELATED APPLICATION

This application claims priority pursuant to 35 U.S.C. 119(a) to European Patent Office Application No. 24159603.0, filed Feb. 26, 2024, which application is incorporated herein by reference in its entirety.

### FIELD OF THE INVENTION

The present disclosure relates to a cutting tool. More specifically, the present disclosure relates to the cutting tool which allows safe and user-friendly handling, assembly, and disassembly of the cutting tool.

### BACKGROUND

Cutting tools such as secateurs, loppers, and pliers are used for performing cutting action using two cutting parts each associated with corresponding handles for ease of handling. Simply put, such tools provide increased mechanical assistance and ease of operation to a common user to conveniently perform operations on objects such as branches having varying dimensions.

However, there may be many instances where working with the cutting tools may wear the cutting parts. The cutting efficiency of the cutting tool may again be restored by replacing the cutting parts which undergo wear or becomes blunt. The replacement of the cutting parts of conventional cutting tools may involve a cumbersome process and may seem highly complex and time consuming, particularly for the common user.

An example of a cutting tool is provided in U.S. Pat. No. 4,341,016 (hereinafter referred to as ‘016 reference). The ‘016 reference provides a hand tool comprising two members, i.e., a male blade and a female blade, each formed with a tang portion which extends within an associated handle. The two members are releasably secured to the associated handles by a pivot bolt which passes through apertures in each member and associated handle.

Another example of the cutting tool is provided in Chinese Utility Model 202,068,767 U (hereinafter referred to as ‘767 reference). The ‘767 reference provides a garden scissoring structure which comprises a first cutting part, a second cutting part, a first grab handle, and a second grab handle. The first cutting part and the second cutting part are coupled to the first grab handle and the second grab handle respectively with screws.

### SUMMARY OF THE INVENTION

In view of the above, it is an objective of the present invention to solve or at least reduce the drawbacks discussed above. The objective is at least partially achieved by a cutting tool according to the present invention.

According to an aspect of the present invention, the cutting tool comprises a first handle, a second handle, a first cutting part comprising a first cutting blade and a first fastening section extending away from the first cutting blade, a second cutting part comprising a second cutting blade and a second fastening section extending away from the second cutting blade, and a biasing means configured to pre-tension the first cutting blade and the second cutting blade away from each other. The first cutting part and the second cutting part are pivotably coupled to each other at a pivot point. Further, the first fastening section is inserted into the first handle, and the second fastening section is inserted into the second handle. The cutting tool is characterized in that the first handle is fixedly coupled with the first fastening section by the biasing means, and the second handle is fixedly coupled with the second fastening section by the biasing means.

The present disclosure advantageously provides an improved cutting tool that primarily comprises two handles, two cutting parts pivotably connected to each other, and the biasing means being toollessly disassemblable and assemblable. (By this, we mean that the biasing means may be assembled and disassembled without the use of tools.) The two handles are the first handle and the second handle that may have a shape and size honoring the ergonomics of the cutting tool, i.e., the first handle and the second handle may have good grip for the hands of the user, and may have size enough to allow sufficient grasp by the user. Further, the two cutting parts are the first cutting part and the second cutting part, wherein the first cutting part comprises the first cutting blade and the first fastening section, and the second cutting part comprises the second cutting blade and the second fastening section. The first fastening section is inserted into the first handle such that the first fastening section is removably coupled to the first handle using the force from the biasing means. The second fastening section is inserted into the second handle such that the second fastening section is removably coupled to the second handle using the force from the biasing means. At the same time, the biasing means is removably connected to the first fastening section and the second fastening section. Thus, the cutting tool may be easy to assemble and disassemble by an end user for maintenance and/or recycling without the need of any tool.

According to an exemplary embodiment of the invention, the biasing means comprises a first end and a second end opposite the first end, wherein first handle is fixedly coupled with the first fastening section by the first end of the biasing means, and the second handle is fixedly coupled with the second fastening section by the second end of the biasing means. The biasing means irrespective of the type of the biasing means may have two ends, namely the first end and the second end disposed at a distance from each other respectively on two opposite ends of the biasing means. The first end may be removably coupled to the first fastening section such that coupling between the first fastening section and the first handle may be possible. Likewise, the second end may be removably coupled to the second fastening section such that coupling between the second fastening section and the second handle may be possible.

According to an exemplary embodiment of the invention, the first end of the biasing means further extends through a first opening, particularly a through opening, in the first handle such that the first handle is fixedly coupled to the first cutting part, and the second end of the biasing means further extends through a second opening, particularly a through opening, in the second handle such that the second handle is fixedly coupled to the second cutting part. The first handle may comprise the first opening and the second handle may comprise the second opening. The through opening may extend through one side wall of the respective handle. Further, the through opening may form a blind hole inside the respective handle, wherein a side wall opposite of the side wall comprising the through opening, may be a side wall without a through opening. The through opening may have any shape and size as per application requirement, the biasing means design, among other factors. The first opening may provide an interface for the first end of the biasing means such that the first end may be plunged into the first handle to be removably engaged or coupled with the first fastening section, particularly in order to allow removable coupling of the first handle with the first fastening section. The second opening may provide an interface for the second end of the biasing means such that the second end may be plunged into the second handle to be removably engaged or coupled with the second fastening section in order to allow removable coupling of the second handle with the second fastening section.

According to an exemplary embodiment of the invention, the first handle and the first fastening section are toollessly coupled, particularly fixedly coupled by hand and without the use of a tool, and/or the second handle and the second fastening section are toollessly coupled, particularly fixedly coupled by hand and without the use of a tool. The cutting tool may be advantageously assembled simply and efficiently by using the restoring force of the biasing means, without the need for any fastening tool and/or fasteners, particularly additional part fasteners.

According to an exemplary embodiment of the invention, the first fastening section comprises a first fastening means, and/or the second fastening section comprises a second fastening means. The first fastening means may be provided with the first fastening section to allow removable engagement between the first fastening section and the first end of the biasing means. The second fastening means may be provided with the second fastening section to allow removable engagement between the second fastening section and the second end of the biasing means. Thereby, the biasing means may substantially at all times be reliably connected or coupled to the first fastening section and the second fastening section to ensure the reliable connection between the first handle and the first cutting part respectively the second handle and the second cutting part.

According to an exemplary embodiment of the invention, the first handle comprises the first opening, wherein the first opening and the first fastening means overlap each other, and are arranged opposite the second fastening section, when the first fastening section is inserted into the first handle. The first fastening means may be formed in the first fastening section in a manner such that when the first fastening section is inserted into the first handle, the first fastening means may face in a direction towards the second cutting part pivotably coupled to the first cutting part at the pivot point.

According to an exemplary embodiment of the invention, the second handle comprises the second opening, wherein the second opening and the second fastening means overlap each other, and are arranged opposite the first fastening section, when the second fastening section is inserted into the second handle. The second fastening means may be formed in the second fastening section in a manner such that when the second fastening section is inserted into the second handle, the second fastening means may face in a direction towards the first cutting part pivotably coupled to the second cutting part at the pivot point. Thus, when the user may operate the cutting tool, the biasing means may get sandwiched or pressed between the first fastening means and the second fastening means and may get restored to original position when the user may release the operating force on the cutting tool, particularly on the first handle and the second handle.

According to an exemplary embodiment of the invention, the first fastening means and the second fastening means are formed substantially identical, and/or wherein the first fastening means and/or the second fastening means is/are a protrusion with two adjacent recesses, and/or wherein the first fastening means and/or the second fastening means is/are configured to engage a respective end of the biasing means. The first fastening means as well as the second fastening means may be substantially identical and comprise a protrusion with two adjacent recesses. For example, when the biasing means may be a compression spring, an end portion of the compression spring may be securely inserted into the recesses and the protrusion may securely support inner surfaces of the end portion of the compression spring. Additionally, the outer edges of the recesses positioned opposite to the protrusion, may securely support outer surfaces of the end portion of the compression spring.

According to an exemplary embodiment of the invention, the first fastening means and/or the second fastening means is/are elongate protrusions configured to engage the respective end of the biasing means. The first fastening means and/or the second fastening means may be an elongate protrusion with any shape and size feasible for smooth assembly of the cutting tool. The first fastening means and the second fastening means may be able to provide firm but removable grip to the first end respectively the second end of the biasing means such that the force from the biasing means is efficiently transferred to the first fastening section as well as the second fastening section supporting toolless coupling of the cutting tool.

According to an exemplary embodiment of the invention, the biasing means is at least one of a compression spring, a coil spring, a spring blade, and a flat spring. The biasing means may be advantageously configured to allow the assembly of the first handle with the first cutting part and the second handle with the second cutting part. The first end of the biasing means may intrude into the first handle (particularly via the first opening in the first handle) and further into the first fastening means. Further, the second end of the biasing means may intrude into the second handle (particularly via the second opening in the second handle and further into the second fastening means. Thereby, the biasing means may fix the first cutting part in the first handle and the second cutting part in the second handle in the toolless, simple, and fast manner.

According to an exemplary embodiment of the invention, the first handle and/or the second handle are formed by at least one of the following: injection molding, aluminum die-casting. zinc die-casting, molding, 3D printing technology, particularly metal or plastics, sintering and punching. The first handle and/or the second handle may be formed from any suitable durable material, particularly durable plastic material, having wear resistant characteristics. When the first handle and/or the second handle are formed by injection molding, the first handle and/or the second handle may be efficiently and economically produced. However, it may be noted that the material and manufacturing technique for manufacturing the first handle and/or the second handle does not limit the scope of the present disclosure in any manner.

According to an exemplary embodiment of the invention, the first handle or the second handle comprises a slidable locking element to selectively lock a rotation of the first cutting part and the second cutting part relative to each other. The cutting tool may have the locking element slidably disposed on one of the handles to slide between a first position and a second position. In the first position, the locking element may entirely lock the rotation of the first cutting blade and the second cutting blade relative to each other. Further, in the second position, the locking element may allow complete and maximal possible rotation of the first cutting blade and the second cutting blade relative to each other. Further, advantageously the locking element may be used for hand-size adjustments. For example, a third position in which the locking element may be slid halfway between the first position and the second position for operation of the cutting tool, may be provided which allows a rotation in an angle used with small-size hands of the user.

According to an exemplary embodiment of the invention, the first cutting part and the second cutting part are pivotably coupled to each other at the pivot point using a locking screw and a tightening nut, particularly a hexagonal nut, knurled nut or notched nut, screwed onto the locking screw. The tightening nut may be any one of the hexagonal nut, knurled or notched nut as per the application requirement, and/or ease of operation of the nut. For example, the knurled nut may be easy to grip and may further be preferred when the first cutting part and the second cutting part of the cutting tool is often required to be decoupled from each other. The locking screw may comprise a head and a shaft portion, in particular wherein the head may comprise an opening, particularly a hexagonal opening, in which a tool may engage.

According to an exemplary embodiment of the invention, the first handle and/or the second handle is/are formed as a substantially non-hollow respectively one-piece structure, wherein the first handle and/or the second handle comprises a receptacle formed inside. Further, the shape of the receptacle formed inside the first handle substantially corresponds to the outer shape of the first fastening section. Thereby, the surface of the receptacle and the outer surface of the first fastening section may be in at least slight contact. Hence, this may contribute to the connection of the first cutting part and the first handle. Additionally, or alternatively, the shape of the receptacle formed in the second handle substantially corresponds to the outer shape of the second fastening section. Thereby, the surface of the receptacle and the outer surface of the second fastening section may be in at least slight contact. Hence, this may contribute to the connection of the second cutting part and the second handle.

According to an exemplary embodiment of the invention, the cutting tool is selected from the group comprising of a secateurs, a shear, a pruner, and a scissor. The secateur, the shear, the pruner, and the scissor may be used in variety of gardening applications such as cutting, pruning, trimming, and shearing of hedges, shrubs, plants, and the like.

According to an exemplary embodiment of the invention, the cutting tool is an anvil cutting tool, or a bypass cutting tool. The cutting tool may be the anvil cutting tool or the bypass cutting tool depending on the type of cutting blades used. The anvil cutting tool may be preferred for cutting finger-thick branches and solid wood whereas the bypass cutting tool may be preferred cutting softer living stems and where sharp, precise cuts may be desired.

Before discussing the invention with the help of the drawings the invention will be briefly discussed in general. A cutting tool is provided with a first handle and an associated first cutting part, a second handle and an associated second cutting part, and a biasing means with a first end and a second end. The first cutting part comprises a first fastening section and a first cutting blade and the second cutting part comprises a second fastening section and a second cutting blade. Further, the first fastening section and the second fastening section comprises a first fastening means and a second fastening means respectively. During assembly of the first handle with the first cutting part and the second handle with the second cutting part, the first end of the biasing means and the second end of the biasing means plunges through the first handle (particularly via a first opening in the first handle) and the second handle (particularly via a second opening in the second handle) respectively and further into the first fastening means and the second fastening means respectively and fixes the first cutting part and the second cutting part in the first handle and the second handle respectively.

The cutting tool according to the present invention may be cost-effective, completely separable, and recyclable.

According to an exemplary embodiment of the invention, the cutting tool may involve fixture of the cutting parts with the biasing means to connect the handles with the cutting parts.

Other features and aspects of this invention will be apparent from the following description and the accompanying drawings.

### BRIEF DESCRIPTION OF THE DRAWINGS

The invention will be described in more detail with reference to the enclosed drawings, wherein:

FIG. 1 illustrates an exploded view of a cutting tool in accordance with an exemplary embodiment of the present disclosure;

FIG. 2 illustrates an assembled view of a cutting tool in accordance with an exemplary first embodiment of the present disclosure;

FIG. 3 illustrates an engagement between a first cutting part, a second cutting part and a biasing means in accordance with an exemplary embodiment of the present disclosure; and,

FIG. 4 illustrates an assembly of a first handle with a first cutting part and a second handle with a second cutting part using a biasing means in accordance with an exemplary embodiment of the present disclosure.

### DETAILED DESCRIPTION OF THE DRAWINGS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention may be utilized in other embodiments and even other types of structures and/or methods. In the drawings, like numbers refer to like elements.

Certain terminology is used herein for convenience only and is not to be taken as a limitation on the invention. For example, “upper”, “lower”, “front”, “rear”, “side”, “longitudinal”, “lateral”, “transverse”, “upwards”, “downwards”, “forward”, “backward”, “sideward”, “left”, “right”, “horizontal”, “vertical”, “upward”, “inner”, “outer”, “inward”, “outward”, “top”, “bottom”, “higher”, “above”, “below”, “central”, “middle”, “intermediate”, “between”, “end”, “adjacent”, “proximate”, “near”, “distal”, “remote”, “radial”, “circumferential”, or the like, merely describe the configuration shown in the Figures. Indeed, the components may be oriented in any direction and the terminology, therefore, should be understood as encompassing such variations unless specified otherwise.

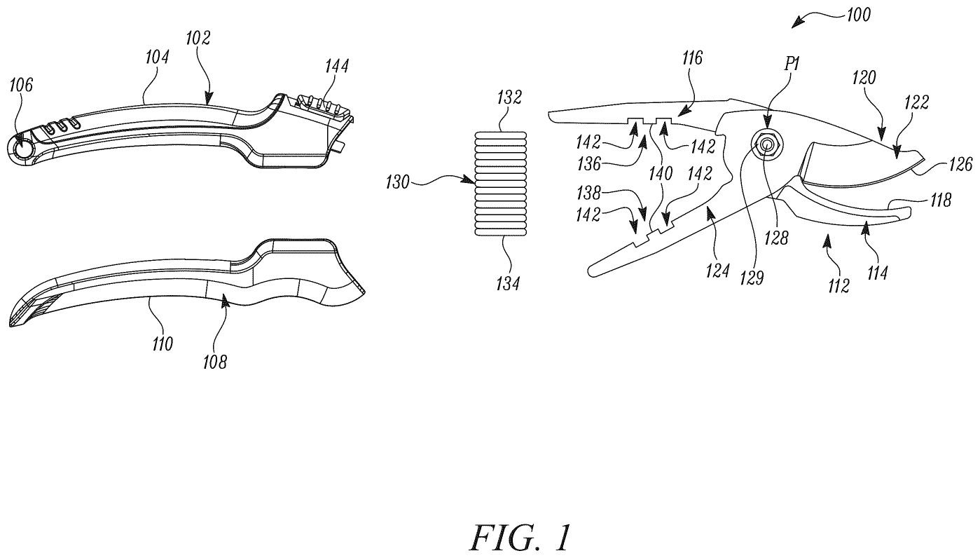

FIG. 1 illustrates an exploded view of a cutting tool 100. The cutting tool 100 is an anvil cutting tool, or a bypass cutting tool selected from the group comprising of a secateurs, a shear, a pruner, and a scissor. Specifically, the cutting tool 100, as illustrated in FIG. 1 is a secateurs.

The cutting tool 100 includes a first handle 102, which is a substantially non-hollow, respectively one-piece structure having a receptacle formed therein, wherein the shape of the receptacle corresponds to the outer shape of the first fastening section 116. Further, the first handle 102 is formed by injection molding. The first handle 102 of the cutting tool 100 includes a first gripping portion 104 to firmly grip the first handle 102 by a user. The first gripping portion 104 has a generally curved profile. The first handle 102 further includes a pass-through hole 106 configured to allow hanging of the cutting tool 100 on a storage rack, or wall when the cutting tool 100 is not in use. The hole 106 may allow passage of a protrusion of the storage rack therethrough, or the hole 106 may allow passage of a fastener coupled with the wall to support hanging of the cutting tool 100. Alternatively, a cord or ribbon may be coupled to the hole 106. The cutting tool 100 also includes a second handle 108, which is a substantially non- hollow respectively one-piece structure having a receptacle formed therein, wherein the shape of the receptacle substantially corresponds to the outer shape of the second fastening section 116. Further, the second handle 108 is formed by injection molding. The second handle 108 of the cutting tool 100 includes a second gripping portion 110 to firmly grip the second handle 108 by the user. The second gripping portion 110 has a generally curved profile. Further, either the first handle 102 or the second handle 108 includes a slidable locking element 144. However, as illustrated in FIG. 1, the first handle 102 includes the slidable locking element 144.

The cutting tool 100 further includes a first cutting part 112. The first cutting part 112 includes a first cutting blade 114 and a first fastening section 116 extending away from the first cutting blade 114. The first cutting blade 114 includes a first cutting edge 118 and the first fastening section 116 includes a first fastening means 136. The first cutting part 112 is formed as a one-piece part and/or is made from metal. Further, the cutting tool 100 includes a second cutting part 120. The second cutting part 120 includes a second cutting blade 122 and a second fastening section 124 extending away from the second cutting blade 122. The second cutting blade 122 includes a second cutting edge 126 and the second fastening section 124 includes a second fastening means 138. The second cutting part 112 is formed as a one-piece part and/or is made from metal. Further, the first fastening means 136 and the second fastening means 138 are formed substantially identical. The first fastening means 136 and the second fastening means 138 as illustrated in FIG. 1, are a protrusion 140 with two adjacent recesses 142. However, the first fastening means 136 and the second fastening means 138 may alternatively and simply be elongate protrusions respectively.

Further, the first cutting part 112 includes a first pivot hole, preferably a circular pivot hole and the second cutting part 120 also includes a second pivot hole, preferably a circular pivot hole, such that the first pivot hole overlaps with the second pivot hole when the first cutting part 112 and the second cutting part 120 are rotatably connected to each other. The first cutting part 112 and the second cutting part 120 are pivotably coupled to each other at a pivot point P1. The pivot point P1 is provided with a locking screw 128 and a tightening nut 129 screwed on the locking screw 128 having a hexagonal outer shape

Further, the cutting tool 100 includes a biasing means 130 configured to pre-tension the first cutting blade 114 and the second cutting blade 122 away from each other. As illustrated in FIG. 1, the biasing means 130 is a compression spring comprising a first end 132 and a second end 134 opposite the first end 132.

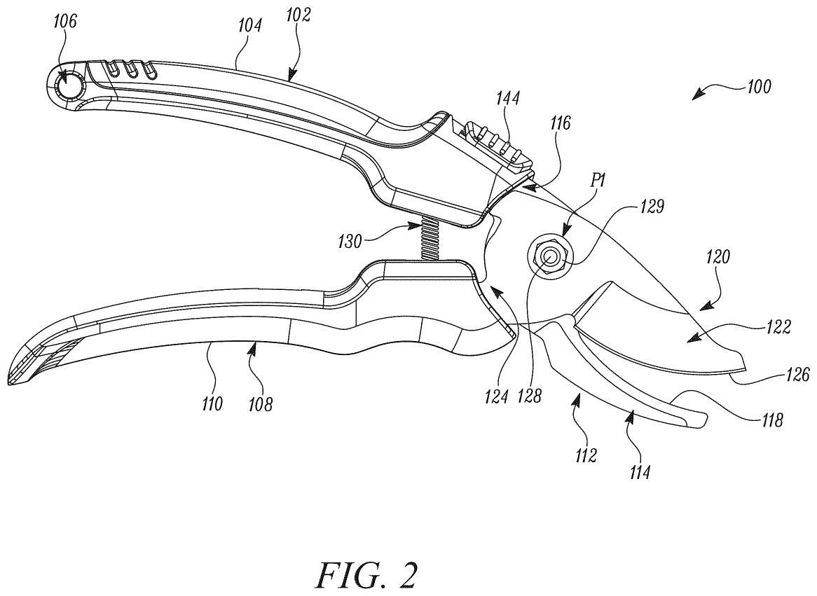

FIG. 2 illustrates an assembled view of the cutting tool 100. The cutting tool 100 comprises the first handle 102 and the second handle 108, the biasing means 130, the first cutting part 112 and the second cutting part 120, wherein the first cutting part 112 and the second cutting part 120 are pivotably coupled to each other at the pivot point P1 such that they removably engage with each other to form a cutting sub-assembly of the cutting tool 100. During assembly of the first handle 102 with the first cutting part 112 and the second handle 108 with the second cutting part 120, the first fastening section 116 is removably inserted into the first handle 102 and the second fastening section 124 are removably inserted into the second handle 108. Further, the first handle 102 is fixedly coupled with the first fastening section 116 by the biasing means 130, and the second handle 108 is fixedly coupled with the second fastening section 124 by the biasing means 130. Thus, the first handle 102 and the first fastening section 116 are toollessly coupled, particularly fixedly coupled by hand and without the use of a tool. Further, the second handle 108 and the second fastening section 124 are toollessly coupled, particularly fixedly coupled by hand and without the use of the tool.

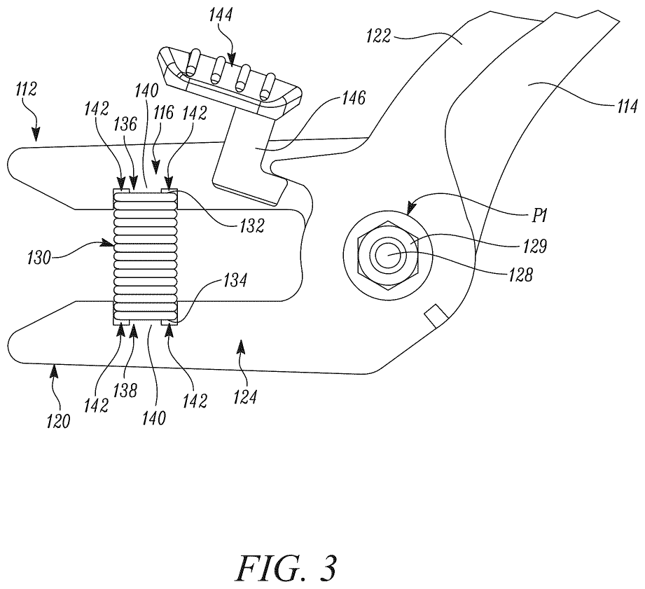

FIG. 3 illustrates an engagement between the first cutting part 112, the second cutting part 120 and the biasing means 130. The biasing means 130 of the present disclosure is configured to allow coupling of the first handle 102 with the first fastening section 116, and the coupling of the second handle 108 with the second fastening section 124, when the first fastening section 116 is inserted into the first handle 102 and the second fastening section 124 is inserted into the second handle 108.

The first handle 102 is fixedly coupled with the first fastening section 116 by the first end 132 of the biasing means 130, and the second handle 108 is fixedly coupled with the second fastening section 124 by the second end 134 of the biasing means 130. Further, the first fastening section 116 includes the first fastening means 136 to engage with the first end 132 of the biasing means 130 and the second fastening section 124 comprises the second fastening means 138 to engage with the second end 134 of the biasing means 130 such that when the first fastening means 136 is engaged with the first end 132 of the biasing means 130 and when the second fastening means 138 is engaged with the second end 134 of the biasing means 130, the biasing means 130 applies a restoring force on the first fastening section 116 and the second fastening section 124 to fixedly couple them with the first handle 102 and the second handle 108 respectively.

The first fastening means 136 as illustrated in FIG. 3, comprises the protrusion 140 with two adjacent recesses 142 to engage the first end 132 of the biasing means 130. The protrusions 140 at least partially engages with an inner surface of the first end 132 of the biasing means 130. The recesses 142 at least partially engage with the outer surface of the first end 132 of the biasing means 130. The second fastening means 138 as illustrated in FIG. 3, comprises the protrusion 140 with two adjacent recesses 142 to engage the second end 134 of the biasing means 130. The protrusion 140 at least partially engages with an inner surface of the second end 134 of the biasing means 130. The recesses 142 at least partially engage with the outer surface of the second end 134 of the biasing means 130.

With continuous reference to FIG. 3, after the assembly of the cutting tool 100 and during the non-use of the cutting tool 100, the cutting tool 100, particularly a rotation of the first cutting part 112 and the second cutting part 120 relative to each other, are locked using slidable locking element 144. In other words, the first handle 102 of the cutting tool 100 includes the slidable locking element 144 to selectively lock the first cutting part 112 and the second cutting part 120 of the cutting tool 100. The slidable locking element 144 includes an L-shaped bracket 146 that selectively engages with a locking protrusion formed at a portion between the second fastening section 124 and the second cutting blade 122 to selectively lock the cutting functionality of the cutting tool 100.

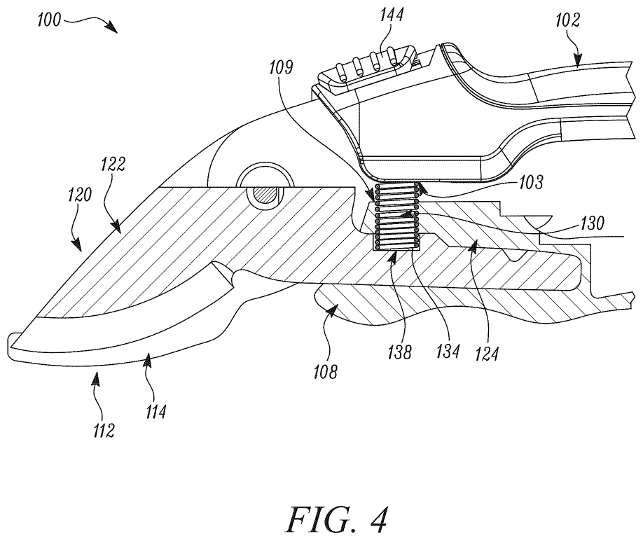

FIG. 4 illustrates an assembly of the first handle 102 with the first cutting part 112 and the second handle 108 with the second cutting part 120 using the biasing means 130. During assembly of the first handle 102 with the first cutting part 112 and the second handle 108 with the second cutting part 120, the first fastening section 116 of the first cutting part 112 is removably inserted into the first handle 102 and the second fastening section 124 of the second cutting part 120 is removably inserted into the second handle 108. The biasing means 130 is configured to allow coupling of the first handle 102 with the first fastening section 116 of the first cutting part 112 and coupling of the second handle 108 with the second fastening section 124 of the second cutting part 120.

Further, the first handle 102 is fixedly coupled with the first fastening section 116 by the first end 132 of the biasing means 130, and the second handle 108 is fixedly coupled with the second fastening section 124 by the second end 134 of the biasing means 130 such that the first end 132 of the biasing means 130 plunges into the first handle 102 to engage with the first fastening means 136 of the first fastening section 116, and the second end 134 of the biasing means 130 plunges into the second handle 108 to engage with the second fastening means 138 of the second fastening section 124.

Further, the first handle 102 includes a first opening 103 such that the first opening 103 and the first fastening means 136 overlap each other when seen in a direction from the second handle 108 towards the first handle 102. Further, the first opening 103 and the first fastening means 136 are arranged opposite the second fastening section 124, when the first fastening section 116 is inserted into the first handle 102. The first end 132 of the biasing means 130 engages with the first fastening means 136 by extending through the first opening 103 particularly a through opening 103 in a side wall of the first handle 102, such that the first handle 102 is fixedly coupled to the first cutting part 112.

Likewise, the second handle 108 comprises a second opening 109, such that the second opening 109 and the second fastening means 138 overlap each other when seen in a direction from the first handle 102 towards the second handle 108. Further, the second opening 103 and the second fastening means 138 are arranged opposite the first fastening section 116, when the second fastening section 124 is inserted into the second handle 108. The second end 134 of the biasing means 130 engages with the second fastening means 138 by extending through the second opening 109, particularly a through opening 109 in a side wall of the second handle 108, such that the second handle 108 is fixedly coupled to the second cutting part 120.

In the drawings and specification, there have been disclosed exemplary embodiments and examples of the invention and, although specific terms are employed, they are used in a generic and descriptive sense only and not for the purpose of limitation of the scope of the invention being set forth in the following claims.

### LIST OF ELEMENTS

100 Cutting Tool
102 First Handle
103 First Opening
104 First gripping portion
106 Hole
108 Second Handle
109 Second Opening
110 Second gripping portion
112 First Cutting Part
114 First Cutting Blade
116 First Fastening Section
118 First Cutting Edge
120 Second Cutting Part
122 Second Cutting Blade
124 Second Fastening Section
126 Second Cutting Edge
128 Locking Screw
129 Tightening Nut
130 Biasing Means
132 First End
134 Second End
136 First Fastening Means
138 Second Fastening Means
140 Protrusion
142 Recesses
144 Slidable Locking Element
146 L-Shaped Bracket
P1 Pivot Point

1. A cutting tool, comprising:
a first handle;
a second handle;
a first cutting part comprising a first cutting blade and a first fastening section extending away from the first cutting blade;
a second cutting part comprising a second cutting blade and a second fastening section extending away from the second cutting blade; and,
a biasing means configured to pre-tension the first cutting blade and the second cutting blade away from each other, wherein the first cutting part and the second cutting part are pivotably coupled to each other at a pivot point, wherein the first fastening section is inserted into the first handle, wherein the second fastening section is inserted into the second handle, characterized in that: wherein the first handle is fixedly coupled with the first fastening section by the biasing means, and wherein the second handle is fixedly coupled with the second fastening section by the biasing means.

2. The cutting tool according to claim 1, wherein the biasing means comprises a first end and a second end opposite the first end; wherein the first handle is fixedly coupled with the first fastening section by the first end of the biasing means; and, wherein the second handle is fixedly coupled with the second fastening section by the second end of the biasing means.

3. The cutting tool according to claim 2, wherein the first end of the biasing means further extends through a first opening, particularly a through opening, in the first handle such that the first handle is fixedly coupled to the first cutting part, and wherein the second end of the biasing means further extends through a second opening, particularly a through opening, in the second handle such that the second handle is fixedly coupled to the second cutting part.

4. The cutting tool according to claim 1, wherein the first handle and the first fastening section are toollessly coupled, particularly fixedly coupled by hand and without the use of a tool, and/or wherein the second handle and the second fastening section are toollessly coupled, particularly fixedly coupled by hand and without the use of a tool.

5. The cutting tool according to claim 1, wherein the first fastening section comprises a first fastening means, and/or wherein the second fastening section comprises a second fastening means.

6. The cutting tool according to claim 5, wherein the first handle comprises the first opening, wherein the first opening and the first fastening means overlap each other, and are arranged opposite the second fastening section, when the first fastening section is inserted into the first handle.

7. The cutting tool according to claim 5, wherein the second handle comprises the second opening, wherein the second opening and the second fastening means overlap each other, and are arranged opposite the first fastening section, when the second fastening section is inserted into the second handle.

8. The cutting tool according to any one of the claims 5, wherein the first fastening means and the second fastening means are formed substantially identical, and/or wherein the first fastening means and/or the second fastening means is/are a protrusion with two adjacent recesses, and/or wherein the first fastening means and/or the second fastening means is/are configured to engage a respective end of the biasing means, and/or in particular wherein the two adjacent recesses are formed adjacent to the protrusion, and on opposite sides of the protrusion.

9. The cutting tool according to any one of the claims 5, wherein the first fastening means and/or the second fastening means is/are an elongate protrusion configured to engage the first end respectively the second end of the biasing means.

10. The cutting tool according to claim 1, wherein the biasing means is at least one of a compression spring, a coil spring, a spring blade, and a flat spring.

11. The cutting tool according to claim 1, wherein the first handle and/or the second handle are formed by at least one of the following: injection molding, aluminum die-casting. zinc die-casting, molding, 3D printing technology, particularly metal or plastics, sintering and punching.

12. The cutting tool according to claim 1, wherein the first handle or the second handle comprises a slidable locking element to selectively lock a relative rotation of the first cutting part and the second cutting part of the cutting tool.

13. The cutting tool according to claim 1, wherein the first cutting part and the second cutting part are pivotably coupled to each other at the pivot point using a locking screw and a tightening nut, particularly a hexagonal nut, a knurled nut or a notched nut, screwed onto the locking screw.

14. The cutting tool according to claim 1, wherein the cutting tool is selected from the group comprising of a secateurs, a shear, a pruner, and a scissor.

15. The cutting tool according to claim 1, wherein the cutting tool is an anvil cutting tool, or a bypass cutting tool.
